(19) United States
(12) Patent Application Publication
(10) Pub. No.: US 2023/0150110 A1
(43) Pub. Date: May 18, 2023

(54) Tool Storage Device

(71) Applicant: Cricut, Inc., South Jordan, UT (US)

(72) Inventors: Ildefonso M. Resuello, Sacramento, CA (US); Thomas Crisp, Cottonwood Heights, UT (US); Grayson Stopp, San Francisco, CA (US); Joaquin Fernandez, Oakland, CA (US)

(73) Assignee: Cricut, Inc., South Jordan, UT (US)

(21) Appl. No.: 17/995,812

(22) PCT Filed: Apr. 9, 2021
(86) PCT No.: PCT/US2021/026570

§ 371 Date: Oct. 7, 2022

Related U.S. Application Data
(60) Provisional application No. 63/008,324, filed on Apr. 10, 2020.

(51) Int. Cl. B25H 3/02

(52) U.S. Cl. CPC B25H 3/022

(57) ABSTRACT

A storage device (10) including a circumferential wall (24) that extends along a longitudinal axis (A-A) from an open first end (24_{P}) to a second end (24_{D}) and circumscribes an internal chamber (40) configured to receive a respective axial portion (202) of a tool (200). The storage device further includes a tool tray (12) that radially extends outward from an axial center of the internal chamber to the circumferential wall. The tool tray includes a top surface (22) configured to support a respective head portion (204) of each tool (200) and one or more troughs (26) formed through the top surface and a bottom surface of the tool tray. Each trough defines a respective width sufficient to prevent passage of the respective head portion through the trough and permit passage of the respective axial portion through the trough when the respective head portion is supported by the top surface.

### TECHNICAL FIELD

The present disclosure relates generally to tool storage devices.

### BACKGROUND

Crafters utilize many kinds of tools to create crafting projects. In some instances, a single crafting project may require the use of two or more different tools that conduct work on a workpiece. Many of these tools have small parts that may be easily lost or misplaced. Such tools may also include a sharp blade. Therefore, a need exists in the art to develop devices that can assist a user in managing tools and associated parts.

### SUMMARY

One aspect of the disclosure provides a container for storing one or more implements. The container includes a first implement tray. The first implement tray includes a sidewall portion and a base portion. The sidewall portion defines a length that extends along a longitudinal axis from a first end of the sidewall portion that forms an opening to a second end of the sidewall portion. The sidewall portion defines an internal chamber that is configured to receive an axial portion of at least one implement of the one or more implements. The base portion is disposed proximate the first end of the sidewall portion and radially extending outward from the longitudinal axis to an inner peripheral surface of the sidewall portion. The base portion also includes a top surface, a bottom surface, and at least one passage. The top surface is configured to support a head portion of the at least one implement of the one or more implements. The bottom surface is disposed opposite the top surface and opposes the internal chamber. The at least one passage is formed through a thickness of the base portion that extends between the top surface and the bottom surface of the base portion. The at least one passage defines a width sufficient to prevent arrangement of the head portion of the at least one implement of the one or more implements through the at least one passage while permitting arrangement of the axial portion of the at least one implement of the one or more implements through the at least one passage when the head portion of the at least one implement of the one or more implements is supported by the top surface.

Implementations of the disclosure may include one or more of the following optional features. In some implementations, when the head portion of the at least one implement of the one or more implements is supported by the top surface of the base portion, the axial portion of the at least one implement of the one or more implements axially extends through the at least one passage from a proximal end of an axial portion of the at least one implement that is attached to the head portion and terminates within the internal chamber at a distal end of the axial portion. In some examples, the distal end of the axial portion of the at least one implement of the one or more implements is disposed within the internal chamber at a location between the bottom surface of the base portion and the second end of the sidewall portion. In other examples, one or more passages of the at least one passage forms a straight cross-sectional shape.

In some implementations, one or more passages of the at least one passage forms an arcuate cross-sectional shape. In other implementations, the at least one passage includes two or more passages, wherein the width of the two or more passages is the same. In yet other implementations, the width is constant along a length of each passage of the one or more passages.

In some configurations, the at least one passage includes two or more passages. The two or more passages include a first passage having an arcuate shape and a second passage having the same arcuate shape as the first trough. In other configurations, the first passage and the second passage are diametrically opposed from one another. In yet other configurations, the two or more passages include a third passage disposed between the first passage and the second passage.

In some examples, the container includes a second implement tray. The second implement tray is removably attached to the first implement tray. The second implement tray includes a base portion and a sidewall portion. The base portion includes a lower surface that is configured to support the second implement tray on a support surface. The sidewall portion forms an open end of the second implement tray. The open end includes an attachment surface configured to mate with a corresponding attachment feature formed by the first end of the sidewall portion of the first implement tray to permit removable attachment of the first implement tray with the second implement tray.

In some implementations, the attachment surface of the open end of the sidewall portion of the second implement tray is configured to mate with the corresponding attachment feature formed by the first end of the sidewall portion of the first implement tray via compression or cooperating threads. In other implementations, a diameter formed by the first end of the sidewall portion of the first implement tray at the opening is different than a diameter of the open end of the sidewall portion of the second implement tray. In other implementations, the first end of the sidewall portion of the first implement tray is configured to support the first implement tray on the support surface when the second implement tray is not attached to the first implement tray. In yet other implementations, an outer surface of the sidewall portion of the second implement tray is radially aligned with an outer surface of the sidewall portion of the first implement tray when the first implement tray is attached to the second implement tray.

In other configurations, the base portion of the second implement tray includes a component receiving surface configured to receive at least one implement of the one or more implements. The component receiving surface of the base portion of the second implement tray is axially spaced apart from the bottom surface of the base portion of the first implement tray when the second implement tray is attached to the first implement tray. In yet other configurations, the component receiving surface defines one or more recesses. Each recess of the one or more recesses is configured to retain the at least one implement of the one or more implements.

In some examples, the container includes a lid that is configured to enclose the base portion of the first implement tray that is arranged near the second end of the sidewall portion of the first implement tray. In other examples, the container includes a hinge defining an axis of rotation substantially perpendicular to the longitudinal axis of the first implement tray. The lid is configured to rotate relative to the first implement tray via the hinge between an open position that permits access the at least one implement of the one or more implements and a closed position that prevents access to the at least one implement of the one or more implements. In yet other examples, the hinge is fixedly attached to one of the lid and the first implement tray for rotatably coupling the other of the lid and the first implement tray. In further examples, the hinge is integrally formed with one of the lid and the first implement tray for rotatably coupling the other of the lid and the first implement tray.

Another aspect of the disclosure provides a tool storage device that includes a circumferential wall and a tool tray. The circumferential wall defines a length that extends along a longitudinal axis from an open first end to a second end. The circumferential wall circumscribes an internal chamber configured to receive a respective axial portion of each tool. The tool tray is disposed proximate the first end of the circumferential wall and radially extends outward from an axial center of the internal chamber to an inner peripheral surface of the circumferential wall. The tool tray includes a top surface configured to support a respective head portion of each tool, a bottom surface disposed on an opposite side of the tool tray than the top surface and opposing the internal chamber, and one or more troughs formed through the top and bottom surfaces of the tool tray. Each trough defines a respective width sufficient to prevent passage of the respective head portion of each tool through the trough and permit passage of the respective axial portion of each tool through the trough when the respective head portion is supported by the top surface.

This aspect may include one or more of the following optional features. In some implementations, at least one of the one or more troughs includes a straight cross-sectional shape and/or at least one of the one or more troughs (26) comprises an arcuate cross-sectional shape. The one or more troughs formed through the top and bottom surfaces of the tool tray may include a first trough having an arcuate shape, a second trough having the same arcuate shape as the first trough, and a third trough disposed between the first trough and the second trough. Here, the first and second troughs may be diametrically opposed from one another.

In some examples, the storage device further includes a base removably attached to the circumferential wall that includes a substantially planar support surface configured to support the base on a surface, an open end, and a peripheral wall extending between the substantially planar support surface and the open end of the base. In these examples, the peripheral wall defines an attachment surface configured to mate with a corresponding attachment feature of the circumferential wall to permit removable attachment between the circumferential wall and the base. An outer surface of the peripheral wall may be radially aligned with an outer surface of the circumferential wall when the base is attached to the circumferential wall. The base may further include a component receiving surface configured to receive subcomponents. The component receiving surface may be coaxial with the tool tray when the circumferential wall is attached to the base. The base may further include a cavity defined by the component receiving surface and the peripheral wall of the base. The storage device may further include a lid configured to enclose the open first end.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective view of a container.

FIG. 2 is a rear view of the container of FIG. 1.

FIG. 3 is a top view of a first implement tray of the container of FIG. 1.

FIG. 4 is a top view of a second implement tray of the container of FIG. 1.

FIG. 5 is another perspective view of the container of FIG. 1 showing the first implement tray of FIG. 3 axially separated from the second implement tray of FIG. 4.

FIG. 6 is another perspective view of the container of FIG. 5 showing both of the first implement tray and the second implement tray arranged upon a surface.

FIG. 7 is a view of a crafting apparatus.

FIG. 8 is a view of an implement assembly that is removably-coupled to the crafting apparatus of FIG. 7 or stowed within the container of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

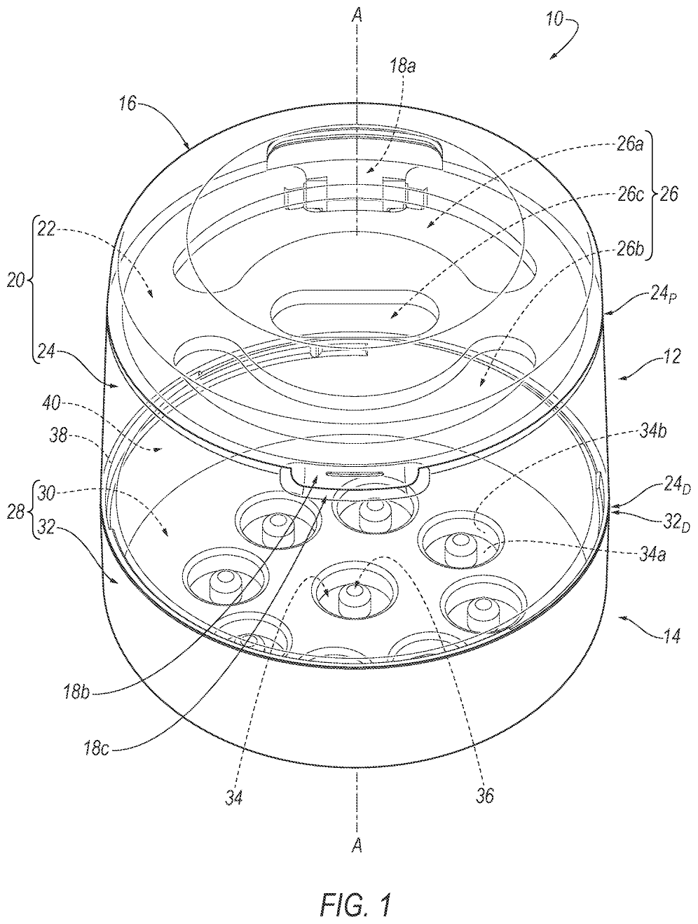

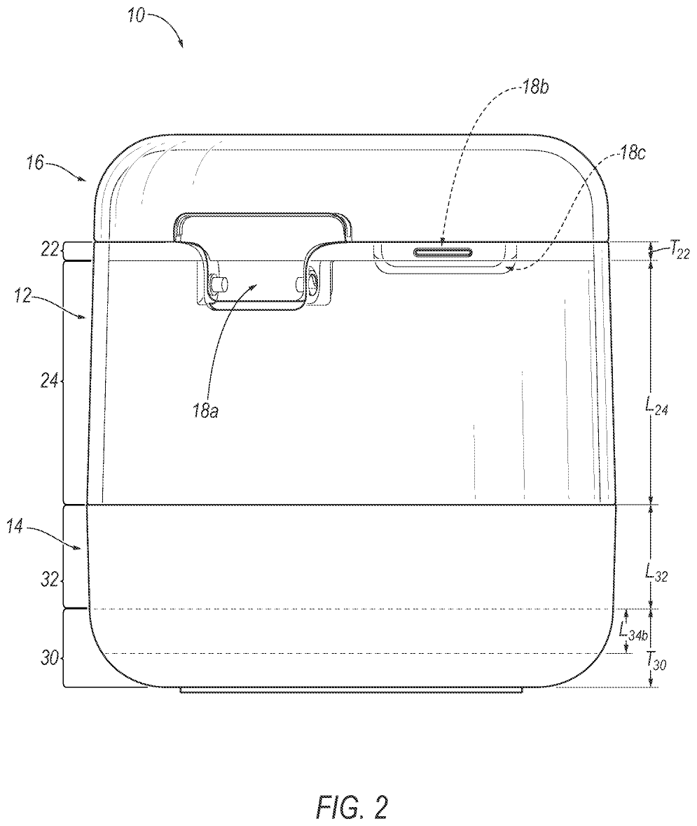

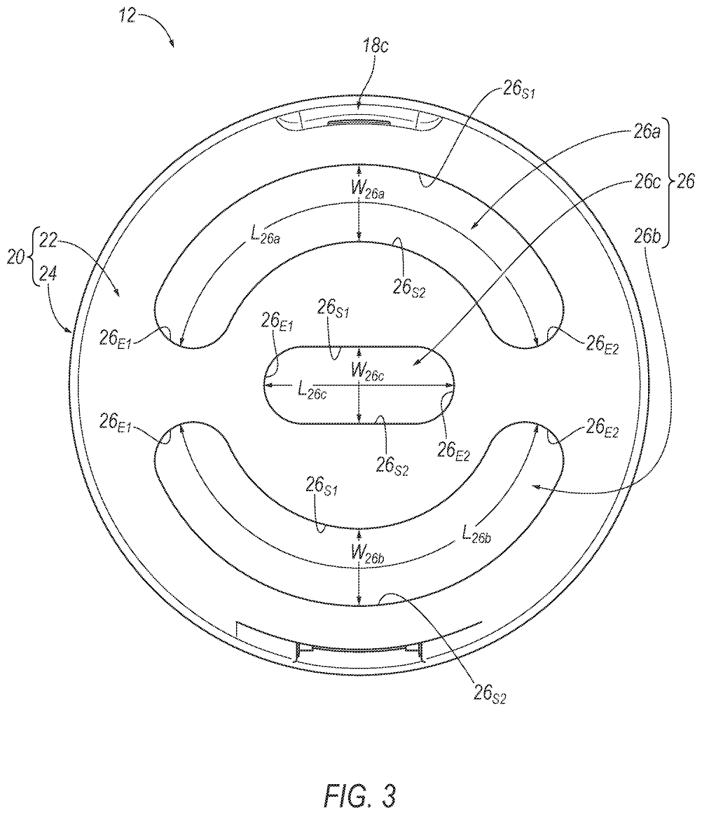

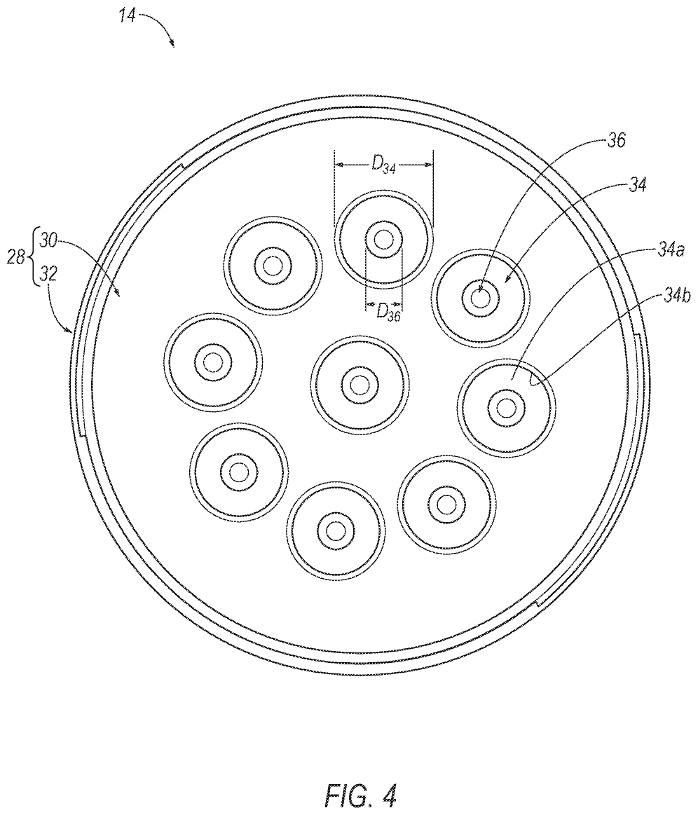

As seen at FIGS. 1-2, an exemplary container is shown generally at 10, which may be alternatively referred to as a storage device. The container 10 may include a first implement tray 12 (see also, e.g., FIG. 3), alone, a second implement tray 14 (see also, e.g., FIG. 4), alone, or, alternatively a combination of the first implement tray 12 removably-connected to the second implement tray 14. The first implement tray 12 may be interchangeably referred to as a tool tray 12, while the second implement tray 14 may be interchangeably referred to as a base 14.

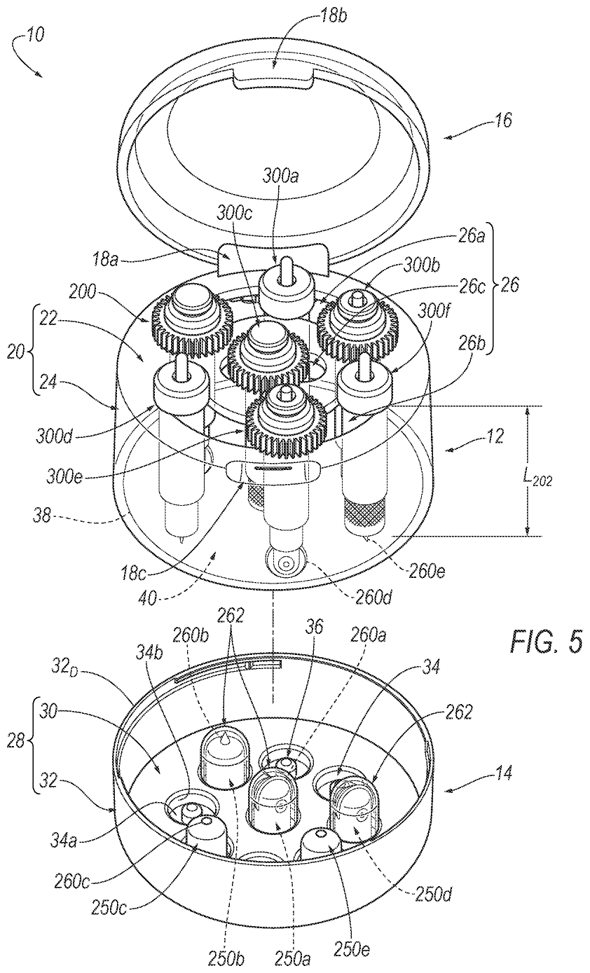

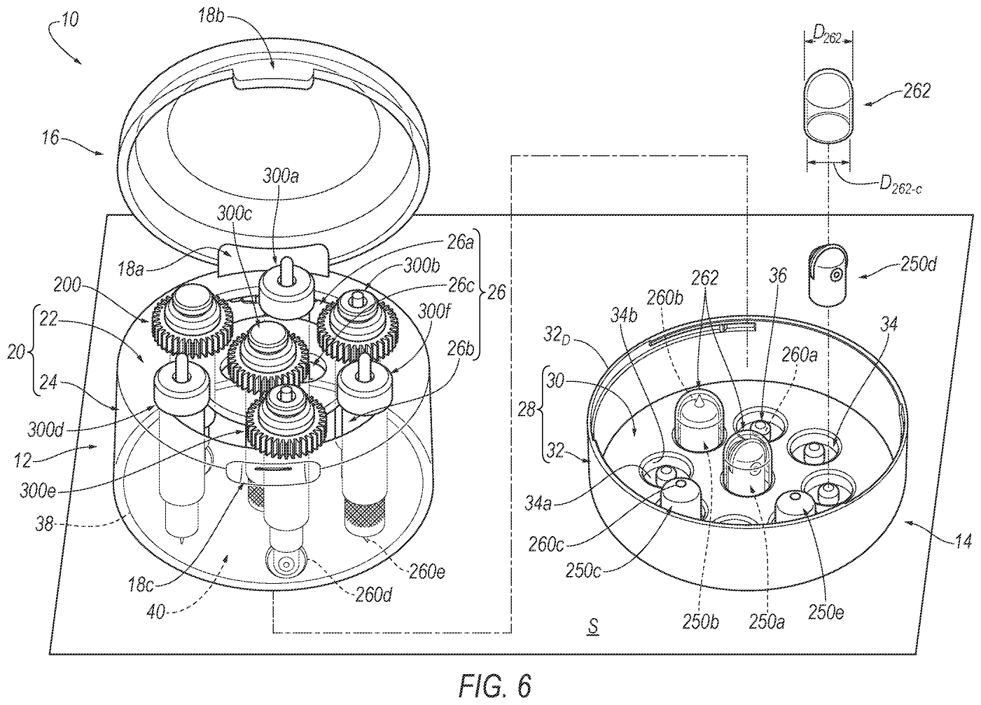

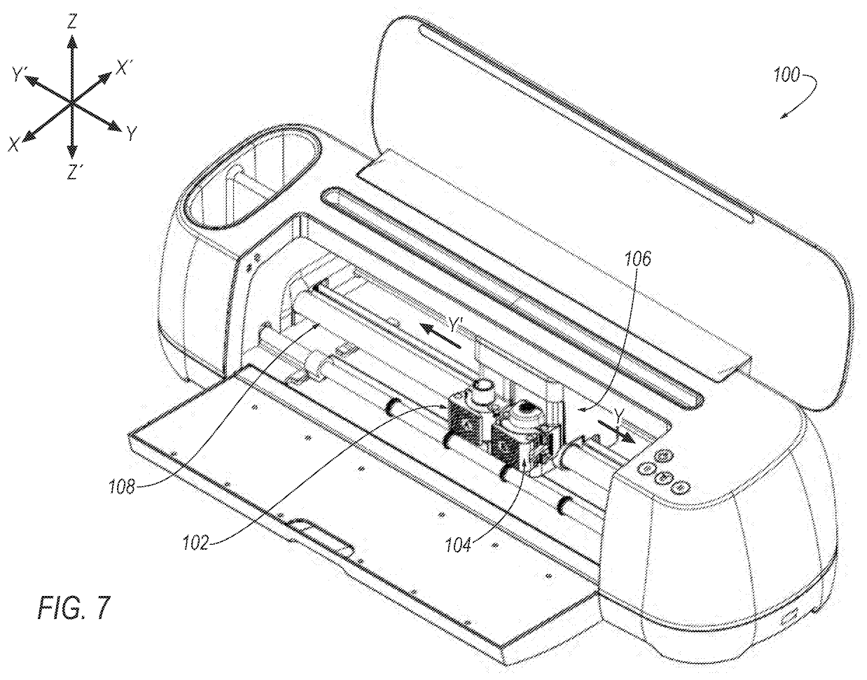

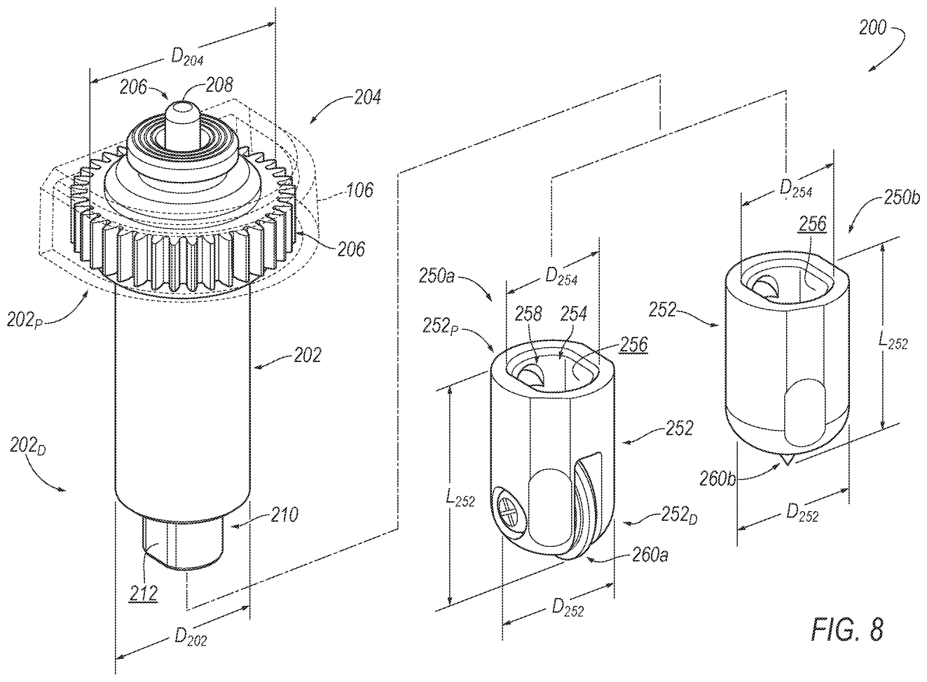

Referring to FIGS. 5-6, the container 10 is configured to axially removably-secure or axially removably-store a plurality of implements (see, e.g., implements 200, 250a-250e, 262, 300a-300f at FIGS. 5-6). At least one implement of the plurality of implements 200, 250a-250e, 262, 300a-300f may be selectively interfaced with a crafting apparatus (see, e.g., crafting apparatus 100 at FIG. 7). An exemplary work-conducting assembly (see, e.g., work-conducting assembly 200 at FIG. 8) may define an implement of the plurality of implements 200, 250a-250e, 262, 300a-300f that may be selectively interfaced with the crafting apparatus 100. Accordingly, any implement of the plurality of implements 200, 250a-250e, 262, 300a-300f may be axially removably-secured or axially removably-stored within the container 10 in order to removably-couple or any implement of the plurality of implements 200, 250a-250e, 262, 300a-300f with the crafting apparatus 100, and then, after utilizing any implement of the plurality of implements 200, 250a-250e, 262, 300a-300f with the crafting apparatus 10, the user may removably-stow the implement of the plurality of implements 200, 250a-250e, 262, 300a-300f within the container 10 for later use.

With reference to FIG. 7, the crafting apparatus 100 may be sized to form a relatively compact shape/size/geometry that permits a user to easily carry/move the crafting apparatus 100 from, for example, one's home to a friend's home where the friend may be hosting, for example, a “scrap-booking party” whereby crafting apparatus 100 may conduct work on a workpiece (not shown). The “work” conducted on the workpiece may be, for example, one or both of a printing operation (conducted by a printing device 102) for printing an image on the workpiece and a cutting operation (conducted by a cutting device 104) for cutting a design out of the workpiece.

In some implementations, the workpiece includes any desirable shape, size, geometry or material composition. The shape/geometry may include, for example, a square or rectangular shape. The material composition of the workpiece may include paper-based (e.g., paperboard or cardboard) and/or non-paper-based products (e.g., vinyl, foam, rigid foam, cushioning foam, plywood, veneer, balsawood or the like). Nevertheless, although various implementations of workpiece material composition may be directed to paper, vinyl or foam-based products, the material composition of the workpiece is not limited to a particular material and may include any material that may be modified during, for example, the cutting operation (i.e., the material defining the workpiece may be defined by a quality that renders the workpiece as being “cuttable”).

The workpiece may be at least partially disposed within the crafting apparatus 100 in order to permit the crafting apparatus 100 to conduct work on the workpiece. The term “work” that is conducted upon the workpiece may include, but is not limited to, any number of tasks/functions performed by one or a combination of the printing device 102 and the cutting device 104. One or both of the printing device 102 and the cutting device 104 may be removably-secured to a carriage 106 that is movably-disposed according to the direction of arrows Y, Y′ (in, e.g., a three dimensional X-Y-Z Cartesian coordinate system) upon a member such as a rod 108, bar or shaft. The movement Y, Y′ of the carriage 106 along the rod 108 may be controlled by a motor (not shown) that receives actuation signals from a central processing unit. In an example, the “work” may include a “cutting operation” that functionally includes contact of a blade (see, e.g., workpiece-engaging portions 260a, 260b, 260c, 260d, 260e at FIGS. 5-6 and 8) of the cutting device 104 with the workpiece. The work conducted by the cutting device 104 arises from movement of the cutting device 104 according to the direction of arrows Z, Z′ in, for example, the three dimensional X-Y-Z Cartesian coordinate system relative to, for example, one or more of the carriage 106 and the rod 108. The movement Z, Z′ of the cutting device 104 may be controlled by one or more motors that receive actuation signals from the central processing unit.

With reference to FIG. 8, certain components of the work-conducting assembly 200 may be interchangeable. These interchangeable components may be disposable, reusable, or some combination of the two. The work-conducting assembly 200 includes an axial portion 202 having a proximal end 202_{P} and a distal end 202_{D}. The proximal end 202_{P} of the axial portion 202 may include, for example, crafting apparatus carriage engagement portion 204, which may be alternatively referred to as a head portion. The crafting apparatus carriage engagement portion 204 may include a circumferentially toothed portion 206 and a plunger portion 208. The circumferentially toothed portion 206 and the plunger portion 208 are configured to engage one or more components of the carriage 106 of the crafting apparatus 100. The one or more components of the carriage 106 of the crafting apparatus 100 may include, for example, a gear (not shown) that engages the circumferentially toothed portion 206 and an axial actuator (not shown) that engages the plunger portion 208.

The distal end 202_{D} of the axial portion 202 includes an interchangeable component engagement portion 210. The interchangeable component engagement portion 210 may include a component engagement surface 212.

With continued reference to FIG. 8, the work-conducting assembly 200 also includes a plurality of interchangeable components, which are shown generally at 250a and 250b; although two interchangeable components are seen at 250a, 250b at FIG. 8, other interchangeable components may be available as well, such as, for example, interchangeable components 250c, 250d, 250e that are seen at FIGS. 5-6. The interchangeable components 250a, 250b, 250c, 250d, 250e may be selectively removably-connected to the interchangeable component engagement portion 210 at the distal end 202_{D} of the axial portion 202.

Each interchangeable component 250a, 250b, 250c, 250d, 250e may include a body 252 having a proximal end 252_{P} and a distal end 252_{D}. A cavity 254 may extend into the proximal end 252_{P} of the body 252. The cavity 254 may be defined by a cavity surface 256. The cavity surface 256 may include at least one detent 258. The distal end 252_{D} of the body 252 of each interchangeable component 250a, 250b, 250c, 250d, 250e includes a workpiece-engaging portion that is shown respectively at 260a, 260b, 260c, 260d, 260e.

The cavity 254 generally defines a female portion that is configured to receive a male portion that is defined by the interchangeable component engagement portion 210 at the distal end 202_{D} of the axial portion 202. Furthermore, one or both of the cavity surface 256 and the at least one detent 258 of the cavity 254 is configured to engage the component engagement surface 212 of the interchangeable component engagement portion 210 and/or an actuator portion (not shown) extending from, connected, or arranged proximate the component engagement surface 212 of the interchangeable component engagement portion 210.

As seen at FIGS. 5, 6, and 8, one or a combination of the body 252 of each interchangeable component 250a, 250b, 250c, 250d, 250e and each workpiece-engaging portion 260a, 260b, 260c, 260d, 260e may have a unique structure, shape, or the like. Furthermore, the structure or shape of the body 252 of each interchangeable component 250a, 250b, 250c, 250d, 250e and each workpiece-engaging portion 260a, 260b, 260c, 260d, 260e may be configured to conduct work on, for example, a specific type of material (e.g., paper, cardboard, nylon, vinyl, wood, metal, plastic, or the like). The interchangeable components may be interchangeably referred to as subcomponents of the tools 200, 300. In other examples, each workpiece-engaging portion 260a, 260b, 260c, 260d, 260e may be configured to have a specific sharpness, dullness, bluntness, or the like. Accordingly, one or a combination of the body 252 of each interchangeable component 250a, 250b, 250c, 250d, 250e and each workpiece-engaging portion 260a, 260b, 260c, 260d, 260e may define each interchangeable component 250a, 250b, 250c, 250d, 250e to function as, for example: a straight blade; a castoring blade; a rotary blade; a serrated edge blade; an embossing tool; a marking tool; or the like.

With reference to FIGS. 7-8 when a user operates the crafting apparatus 100, the user may selectively configure the distal end 202_{D} of the axial portion 202 with a desired interchangeable component 250a, 250b, 250c, 250d, 250e. As described above, each interchangeable component 250a, 250b, 250c, 250d, 250e may be configured to perform a desired task (e.g., cutting, perforating, embossing, marking, or the like) in the course of conducting work on a workpiece (that may be defined by, for example, a material, such as, for example, paper, cardboard, nylon, vinyl, wood, metal, plastic, or the like that may have a known hardness). Accordingly, after selectively configuring the distal end 202_{D} of the axial portion 202 with a desired interchangeable component 250a, 250b, 250c, 250d, 250e, the user may selectively interface the crafting apparatus carriage engagement portion 204 with the carriage 106 of the crafting apparatus 100 for conducting work on the workpiece.

Although the work-conducting assembly 200 may include the axial portion 202 and a plurality of interchangeable components (e.g., sub-components) 250a-250e, other work-conducting assemblies 300a, 300b, 300c, 300d, 300e, 300f (see, e.g., FIGS. 5-6) may similarly include an axial portion (that is substantially similar to the axial portion 202) having a non-interchangeable workpiece-engaging portion (that is substantially similar to the workpiece-engaging portions 260a, 260b, 260c, 260d, 260e). Accordingly, the user may selectively engage other such work-conducting assemblies 300a, 300b, 300c, 300d, 300e, 300f with the carriage 106 of the crafting apparatus 100. Such work-conducting assemblies 300a, 300b, 300c, 300d, 300e, 300f also include a crafting apparatus carriage engagement portion (that is substantially similar to the crafting apparatus carriage engagement portion 204) that may or may not include a circumferentially toothed portion, a plunger portion, or the like.

In view of the above description, a user may obtain a large collection of work-conducting assemblies 200, 300a-300f and interchangeable components 250a-250e (which may be hereinafter collectively referred to as the plurality of implements 200, 250a-250e, 300a-300f). The work-conducting assemblies 200, 300a-f may be interchangeably referred to as tools 200, 300a-f. During the course of utilizing the crafting apparatus 100 for conducting a crafting operation on a workpiece, the user may wish to selectively interface any implement of the plurality of implements 200, 250a-250e, 300a-300f with the crafting apparatus 100 in order to, for example, conduct one or more specific cutting operations on one or more workpieces (e.g., by dragging a straight blade 260e in a linear fashion across one or more workpieces, or, for example, by utilizing a castoring blade 260d for performing a cutting operation on one or more workpieces in a curved or arcuate fashion). Accordingly, the container 10 may assist the user in not only collectively containing and organizing the plurality of implements 200, 250a-250e, 300a-300f for quick identification and access by the user, but, also, for preventing the workpiece-engaging portions 260a-260e, which may or may not be sharp, from being directly exposed to a surrounding environment.

Referring to FIG. 1, in some implementations, the container 10 includes an implement tray 12 that is configured to axially removably-secure or axially removably-store a plurality of implements defined by, for example, the work-conducting assemblies 200, 300a-300f (as seen at, for example, FIGS. 5-6). In other implementations, the container 10 includes an implement tray 14 that is configured to axially removably-secure or axially removably-store a plurality of implements defined by, for example, the interchangeable components 250a-250e, 262 (as seen at, for example, FIGS. 5, 6, and 8).

In other configurations, the implement tray 12 may be alternatively referred to as a first implement tray, and, the implement tray 14 may be alternatively referred to as a second implement tray; accordingly, in yet other implementations, the container 10 includes a first implement tray 12 and a second implement tray 14 whereby the second implement tray 14 is configured to axially support, in a stacked orientation, the first implement tray 12. Therefore, in some configurations, one of the implement tray 12 and the second implement tray 14 may be an optional component (i.e., the implement tray 12 may function independently of the implement tray 14, and, conversely, the implement tray 14 may function independently of the implement tray 12).

In other configurations, the implement tray 12 may include an optional lid 16. As seen at FIGS. 1 and 2, the optional lid 16 may include an optional hinge portion 18a and an optional flange portion 18b arranged opposite the optional hinge portion 18a. The optional hinge portion 18a hingedly-connects the optional lid 16 to the implement tray 12 for arrangement of the optional lid 16 relative the implement tray 12 in one of a closed or down orientation (see, e.g., FIGS. 1-2) and an opened or up orientation (see, e.g., FIGS. 5-6). Functionally, the optional flange portion 18b may provide a region where a user's finger may apply a lifting force for rotating the optional lid 16 relative the implement tray 12 at the optional hinge portion 18a for arranging the optional lid 16 in the opened or up orientation.

When the optional lid 16 is arranged in the closed or down orientation, the optional flange portion 18b may mate with or be registered adjacent a ledge surface or female flange-receiving region 18c (see e.g., FIGS. 3, 5, and 6) formed by one or more portions (e.g., a base portion 22 and a sidewall portion 24) of the implement tray 12. The base portion 22 may be interchangeably referred to as a top surface 22 of the tool tray 12 and the sidewall portion 24 may be interchangeably referred to as a circumferential wall 24 that circumscribes the cavity 40. In some configurations, the optional flange portion 18b may be matingly-joined to the ledge surface or female flange-receiving region 18c in a friction-fit or snap-detent configuration in order to selectively retain or selectively lock the optional lid 16 in the closed or down orientation with respect to the implement tray 12.

Referring to FIGS. 1, 3, 5, and 6, the implement tray 12 may include a cup-shaped body 20 formed by the base portion 22 and the sidewall portion 24 that extends axially away from an outer end of the base portion 22. With reference to FIG. 3 (and also to FIGS. 1, 5, and 6), the base portion 22 of the implement tray 12 includes one or more passages 26. The one or more passages 26 may be interchangeably referred to as one or more troughs 26. Each passage/trough 26 extends through a thickness T₂₂ (see, e.g., FIG. 2) of the base portion 22. As seen at FIGS. 5-6, the plurality of passages 26 are sized for axially removably-securing or axially removably-storing the plurality of implements defined by the work-conducting assemblies 200, 300a-300f.

As seen at FIG. 3, the plurality of passages 26 may include, for example, three passages defined by a first passage 26a, a second passage 26b, and a third passage 26c. The first passage 26a and the second passage 26b may include a similar shape while being symmetrically arranged with respect to one another, or, alternatively, being diametrically opposed to one another; the third passage 26c may be arranged centrally between the first passage 26a and the second passage 26b, while defining a line of symmetry between the first passage 26a and the second passage 26b. Each of the first passage 26a, the second passage 26b, and the third passage 26c includes a first end surface 26_{E1}, a second end surface 26_{E2}, a first side surface 26_{S1}, and a second side surface 26_{S2}. The first end surface 26_{E1} is arranged opposite the second end surface 26_{E2}. The first side surface 26_{S1} is arranged opposite the second side surface 26_{S2}.

Each of the first passage 26a, the second passage 26b, and the third passage 26c are respectively defined by a length L₂₆ₐ, L_{26b}, L_{26c} extending between the first end surface 26_{E1} and the second end surface 26_{E2}. The length L₂₆ₐ, L_{26b} of each of the first passage 26a, the second passage 26b may be greater than the length L₂₆ of the third passage 26c. Furthermore, the first passage 26a and the second passage 26b may be defined by an arcuate shape, and, as such, include an arcuate length L₂₆ₐ, L_{26b}. Unlike the arcuate shape of the first passage 26a and the second passage 26b, the third passage 26c may be defined by a linear shape, and, as such, includes a linear length L_{26c}.

Each of the first passage 26a, the second passage 26b, and the third passage 26c are respectively defined by a width W₂₆ₐ, W_{26b}, W_{26c} extending between the first side surface 26_{S1} and the second side surface 26_{S2}. The width W₂₆ₐ, W_{26b}, W_{26c} of each of the first passage 26a, the second passage 26b, and the third passage 26c may be equal to one another.

The width W₂₆ₐ, W_{26b}, W_{26c} of each of the first passage 26a, the second passage 26b, and the third passage 26c may be: (1) about the same as but greater than a first dimension (e.g., a diameter D₂₀₂ as seen at FIG. 8) of the axial portion 202 of the work-conducting assembly 200 (as well as a similar axial portion of any of the other work-conducting assemblies 300a, 300b, 300c, 300d, 300e, 300f); and (2) about the same as but less than a second dimension (e.g., a diameter D₂₀₄ as seen at FIG. 8) of, for example, the crafting apparatus carriage engagement portion 204 of the work-conducting assembly 200, which may be, for example, the circumferentially toothed portion 206 of the crafting apparatus carriage engagement portion 204 of the work-conducting assembly 200 (as well as a similar crafting apparatus carriage engagement portion of any of the other work-conducting assemblies 300a, 300b, 300c, 300d, 300e, 300f).

Accordingly, as seen at FIGS. 5-6, the axial portions 202 of the work-conducting assemblies 200, 300a, 300b, 300c, 300d, 300e, 300f are permitted to be arranged within and axially extend through any of the first passage 26a, the second passage 26b, and the third passage 26c while the crafting apparatus carriage engagement portions 204, 304 of the work-conducting assemblies 200, 300a, 300b, 300c, 300d, 300e, 300f are permitted to be disposed adjacent and axially supported by the base portion 22 of the implement tray 12. Furthermore, as seen at FIGS. 5-6, the sidewall portion 24 of the implement tray 12 extends axially away from the outer end of the base portion 22 at a length L₂₄ (see, e.g., FIG. 2) of the sidewall portion 24. The length L₂₄ of the sidewall portion 24 may be greater than a length L₂₀₂ (see, e.g., FIGS. 5-6) extending between the proximal end 202_{P} of the axial portion 202 and a distal-most tip or point of the workpiece-engaging portions 260a-260e, 360a-360e of the work-conducting assemblies 200, 300a, 300b, 300c, 300d, 300e, 300f, which is arranged near the distal end 202_{D} of the axial portion 202. Accordingly, if the implement tray 12 is not arranged in a stacked orientation upon the implement tray 14, but, rather, is disposed upon a support surface S (as seen at FIG. 6), the length L₂₄ of the sidewall portion 24 results in the distal-most tip or point of the workpiece-engaging portions 260a-260e, 360a-360e of the work-conducting assemblies 200, 300a, 300b, 300c, 300d, 300e, 300f being arranged at a distance away from the support surface S such that the distal-most tip or point of the workpiece-engaging portions 260a-260e, 360a-360e does not contact the support surface S.

Referring to FIGS. 1-2 and 4-6, the implement tray 14 may include a cup-shaped body 28 including a base portion 30 and a sidewall portion 32 extending away from an outer end of the base portion 30. Referring to FIG. 4, the base portion 30 of the implement tray 14 includes a plurality of recesses 34. Each recess 34 of the plurality of recesses may be defined by a floor surface 34a and a sidewall surface 34b.

Each recess 34 of the plurality of recesses 34 is sized for axially removably-securing or axially removably-storing an implement of the plurality of implements defined by the interchangeable components 250a-250e. Unlike the plurality of passages 26 formed by the base portion 22 of the implement tray 12, the plurality of recesses 34 do not extend all the way through a thickness T₃₀ (see, e.g., FIG. 2) of the base portion 30 of the implement tray 14; rather, the sidewall surface 34b of each recess 34 of the plurality of recesses 34 extend into the thickness T₃₀ of the base portion 30 of the implement tray 14 at a dimension defined by a length L_{34b} (see, e.g., FIG. 2) that is less than the thickness T₃₀ of the base portion 30 of the implement tray 14.

Furthermore, as seen at FIGS. 1 and 4-6, the base portion 30 may include a plurality of projections 36. The sidewall surface 34b of each recess 34 of the plurality of recesses 34 may surround a projection 36 of the plurality of projections 36. In some configurations, the sidewall surface 34b of each recess 34 may be defined by a dimension (see, e.g., a diameter D₃₄ at FIG. 4), and, in some configurations, the projection 36 that is surrounded by the sidewall surface 34b of the recess 34 may be centrally located within the recess 34. The projection 36 may also be defined by a dimension (see, e.g., a diameter D₃₆ at FIG. 4) that is less than the dimension (see, e.g., the diameter D₃₄) of each recess.

In some configurations, the dimension (e.g., the diameter D₃₄) of each recess 34 of the plurality of recesses 34 may be about the same as but greater than a first dimension (e.g., a diameter D₂₅₂ as seen at FIG. 8) of the body 252 of each interchangeable component 250a, 250b, 250c, 250d, 250e of the work-conducting assembly 200 in order to permit any interchangeable component of the plurality of interchangeable components 250a, 250b, 250c, 250d, 250e to be axially removably-secured or axially removably-stored within the each recess 34 of the plurality of recesses 34. In other configurations, a dimension (e.g., the diameter D₃₆) of each projection 36 of the plurality of projections 36 may be about the same as but slightly greater than a second dimension (e.g., a diameter D₂₅₄ as seen at FIG. 8) of the cavity 254 of each interchangeable component 250a, 250b, 250c, 250d, 250e of the work-conducting assembly 200 in order to permit a projection 36 of the plurality of projections to be, for example, friction-fit disposed within the cavity 254 of each interchangeable component 250a, 250b, 250c, 250d, 250e of the work-conducting assembly 200 in order to permit any interchangeable component of the plurality of interchangeable components 250a, 250b, 250c, 250d, 250e to be axially removably-secured or axially removably-stored within the each recess 34 of the plurality of recesses 34.

Furthermore, as seen at FIG. 2, the sidewall portion 32 of the implement tray 14 extends axially away from the outer end of the base portion 30 at a length L₃₂. A collective length formed by the length L₃₂ of the sidewall portion 32 and the length L_{34b} of the sidewall surface 34b of each recess 34 may be greater than a length L₂₅₂ (see, e.g., FIG. 8) extending between the proximal end 252_{P} of the body 252 and a distal-most tip or point of the workpiece-engaging portions 260a-260e, 360a-360e of each interchangeable component 250a, 250b, 250c, 250d, 250e of the work-conducting assembly 200, which is arranged near the distal end 252_{D} of the body 252 of each interchangeable component 250a, 250b, 250c, 250d, 250e of the work-conducting assembly 200. Accordingly, if the implement tray 12 is not arranged in a stacked orientation upon the implement tray 14, but, rather, is disposed upon a support surface S (as seen at FIG. 6), a collective length formed by the length L₃₂ of the sidewall portion 32 and the length L_{34b} of the sidewall surface 34b of each recess 34 results in the distal-most tip or point of the workpiece-engaging portions 260a-260e, 360a-360e of each interchangeable component 250a, 250b, 250c, 250d, 250e of the work-conducting assembly 200 being contained within the implement tray 14 such that a user's hand or palm may engage and come into contact with the a distal end 32_{D} (see, e.g., FIGS. 5-6) of the sidewall portion 32 and not the workpiece-engaging portions 260a-260e, 360a-360e of each interchangeable component 250a, 250b, 250c, 250d, 250e.

With reference to FIGS. 1-6, in some embodiments, the sidewall portion 24 of the implement tray 12 and the sidewall portion 32 of the implement tray 14 may define the container 10 to have a generally cylindrical shape. The generally cylindrical shape may maximize a ratio between volume available for storage of the plurality of implements 200, 250a-250e, 300a-300f. In this way, embodiments of the container 10 described herein may be configured to be compact and convenient to transport and store as needed while still providing sufficient storage space for all of the plurality of implements 200, 250a-250e, 300a-300f of the crafting apparatus 100.

In some instances, as shown at FIG. 1, the implement tray 12 may be cylindrical in shape and capped at a proximal end 24_{P} of the sidewall portion 24 by the optional lid 16 and at a distal end 24_{D} of the sidewall portion 24 by the distal end 32_{D} of the sidewall portion 32 of the implement tray 14 (each of which may have chamfered or otherwise sloping/curving edges). As shown at FIGS. 1-2, the sidewall portion 24 extends perpendicularly from an outer edge of the base portion 22, which may form a substantially cylindrical tube-shape. In some embodiments, as seen at FIG. 1, the base portion 22 at least partially encloses implement tray 12 at the proximal end 24_{P} of the sidewall portion 24 whereas the distal end 24_{D} of the sidewall portion 24 is not enclosed and forms an opening 38 that permits access to a cavity 40 (see, e.g., FIGS. 1-2 and 5-6), which may alternatively be referred to as a chamber, formed by the base portion 22 and the sidewall portion 24. The cavity 40 extends at a distance along the length L₂₄ of the sidewall portion 24 between the proximal end 24_{P} of the sidewall portion 24 and the distal end 24_{D} of the sidewall portion 24. The distal end 24_{D} of the sidewall portion 24 of the implement tray 12 is configured to interface with and be disposed adjacent the distal end 32_{D} of the sidewall portion 32 of the implement tray 14.

With reference to FIGS. 5-6, the first implement tray 12 and the second implement tray 14 are removably secured together such that first implement tray 12 and the second implement tray 14 can be separated from one another and functionally operate independently from one another (i.e., the container 10 may be defined by, for example: (1) the first implement tray 12 alone; (2) the second implement tray 14 alone; or (3) a combination of the first implement tray 12 and the second implement tray 14 together as seen at FIGS. 1-2. As seen in FIG. 6, the first implement tray 12 and the second implement tray 14 can be separated from one another whereby each of the first implement tray 12 and the second implement tray 14 can be set down onto the surface S, such as, for example, a surface of a table.

In some instances, the distal end 24_{D} of the sidewall portion 24 of the implement tray 12 is secured together with the distal end 32_{D} of the sidewall portion 32 of the implement tray 14 via, for example, compression (such as, e.g., a releasable friction-fit or snap-fit locking configuration whereby one of the distal end 24_{D} of the sidewall portion 24 and the distal end 32_{D} of the sidewall portion 32 may include a lip and the other includes a recess that releaseably-interlock with one another). In other configuration, of the distal end 24_{D} of the sidewall portion 24 and the distal end 32_{D} of the sidewall portion 32 may include a threaded surface portion in order to threadably-engage or threadably-couple the distal end 24_{D} of the sidewall portion 24 with the distal end 32_{D} of the sidewall portion 32. Accordingly, a user may attach or separate implement tray portion 12 to/from the implement tray 14 by, for example, twisting, pulling, or otherwise manipulating or unlocking the implement tray 12 and the implement tray 14. In other configurations, a diameter formed by the distal end 24_{D} of the sidewall portion 24 of the first implement tray 12 at the opening 38 is different (e.g., smaller or greater) than a diameter of the distal end 32_{D} of the sidewall portion 32 of the second implement tray 14 in order to permit one of the distal end 24_{D} of the sidewall portion 24 of the first implement tray 12 and the distal end 32_{D} of the sidewall portion 32 of the second implement tray 14 to removably-capture, and, therefore, couple, the other of the distal end 24_{D} of the sidewall portion 24 of the first implement tray 12 and the distal end 32_{D} of the sidewall portion 32 of the second implement tray 14.

One or more portions (e.g., the optional lid 16, the base portion 22, and the sidewall portion 24) of the implement tray 12 may be formed from any desirable material. In some configurations, one or more of the optional lid 16, the base portion 22, and the sidewall portion 24 may be formed from a transparent material in order to allow a user to easily view which and how many implements of the plurality of implements 200, 250a-250e, 300a-300f are disposed within the container 10.

With reference to FIG. 3, although the base portion 22 of the implement tray 12 is shown to include the plurality of passages 26 defined by three passages (e.g., the first passage 26a, the second passage 26b, and the third passage 26c), the base portion 22 may include any number of passages 26. For example, the plurality of passages 26 may include one, two, three, four, or more passages 26 without departing from the spirit, functionalities, and advantages of the present disclosure. Additionally, or alternatively, some configurations of the implement tray 12 may include one or more passages 26 extending elsewhere through implement tray 12, such as, for example, at any region of the sidewall portion 24 of the implement tray 12.

Although the plurality of implements 200, 250a-250e, 300a-300f shown at FIGS. 5-6 and 8 include a generally cylindrical shape, the container 10 is not limited containing implements that have a generally cylindrical shape; accordingly, the container 10 may be configured to accommodate implements of other shapes, such as, for example, a square shape, a polygonal prism shape, or other irregularly shaped implements based on the dimensional principles described herein related to the widths W₂₆ₐ, W_{26b}, W_{26c} extending between the first side surface 26_{S1} and the second side surface 26_{S2} of each of the first passage 26a, the second passage 26b, and the third passage 26c whereby a dimension (e.g., a diameter D₂₀₄ as seen at FIG. 8) of, for example, the circumferentially toothed portion 206 of the crafting apparatus carriage engagement portion 204 of the work-conducting assembly 200 is greater than any of the widths W₂₆ₐ, W_{26b}, W_{26c} extending between the first side surface 26_{S1} and the second side surface 26_{S2} of each of the first passage 26a, the second passage 26b, and the third passage 26c in order to permit the implement tray 12 to store any of the plurality of implements 200, 300a-300f.

In some configurations, a dimension (e.g., the diameter D₃₄) of each recess 34 of the plurality of recesses 34 may be configured to not only accommodate a dimension (e.g., the diameter D₂₅₂ as seen at FIG. 8) of the body 252 of each interchangeable component 250a, 250b, 250c, 250d, 250e of the work-conducting assembly 200 but also another device that may be associated one or more component of the plurality of interchangeable component 250a, 250b, 250c, 250d, 250e of the work-conducting assembly 200. As seen at FIGS. 5-6, for example, a cap, covering or protector 262 may be removably-coupled to one or more component of the plurality of interchangeable component 250a, 250b, 250c, 250d, 250e of the work-conducting assembly 200. Accordingly, the dimension (e.g., the diameter D₃₄) of each recess 34 of the plurality of recesses 34 may also be configured to accommodate a dimension (e.g., a diameter D₂₆₂) of the cap, covering or protector 262. In some instances, each recess 34 of the plurality of recesses 34 may be about the same as but greater than the dimension (see, e.g., a diameter D₂₆₂ at FIG. 6) of the cap, covering or protector 262; furthermore, the dimension (e.g., the diameter D₂₅₂) of the body 252 of each interchangeable component 250a, 250b, 250c, 250d, 250e of the work-conducting assembly 200 may be less than a cavity dimension (see, e.g., a diameter D_{262-C} at FIG. 6) of the cap, covering or protector 262 in order to permit any interchangeable component of the plurality of interchangeable components 250a, 250b, 250c, 250d, 250e to be axially removably-secured or axially removably-stored within the cap, covering or protector 262 such that both of the cap, covering or protector 262 and the interchangeable component of the plurality of interchangeable components 250a, 250b, 250c, 250d, 250e are removably-secured within a recess 34 of the plurality of recesses 34.

In a substantially similar manner as described above with respect to the widths W₂₆ₐ, W_{26b}, W_{26c} extending between the first side surface 26_{S1} and the second side surface 26_{S2} of each of the first passage 26a, the second passage 26b, and the third passage 26c of the base portion 22 with respect to the implement tray 12 being configured to be interfaced with the plurality of implements 200, 250a-250e, 300a-300f having any type of shape (e.g., a cylindrical shape, a square shape, a polygonal prism shape, or other irregularly shaped implements), the same principle may also apply to the plurality of recesses 34 formed by the base portion 30 of the implement tray 14. Accordingly, the plurality of recesses 34 formed by the base portion 30 of the implement tray 14 may be configured to removably-support and/or removably-retain any implement that may, for example, be utilized in conducting a crafting procedure, which may or may not be associated with operation of the crafting apparatus 100.

In some configurations, the plurality of recesses 34 formed by the base portion 30 of the implement tray 14 may support the plurality of interchangeable components 250a, 250b, 250c, 250d, 250e and/or the cap, covering or protector 262 via a friction-fit connection and/or gravity. In some configurations, the base portion 30 may be formed of an elastic material such that the plurality of recesses 34 formed by the base portion 30, which may include a dimension (e.g., the diameter D₃₄) that is smaller than a dimension (e.g., the diameter D₂₅₂ and/or the diameter D₂₆₂) of the body 252 of each interchangeable component 250a, 250b, 250c, 250d, 250e and/or of the cap, covering or protector 262, such that each recess 34 of the plurality of recesses 34 can stretch to frictionally-retain, and, therefore, also accommodate larger or different sized implements that may be removably-connected to the implement tray 14. Accordingly, when, for example, of the body 252 of each interchangeable component 250a, 250b, 250c, 250d, 250e and/or of the cap, covering or protector 262 is frictionally-retained within one or more recesses 34 of the plurality of recesses 34, if the implement tray 14 is arranged in an “upside-down” orientation, tipped-over, or dropped, each interchangeable component 250a, 250b, 250c, 250d, 250e and/or of the cap, covering or protector 262 may be secured within the one or more recesses 34 of the plurality of recesses 34 without being dislodged therefrom.

In a substantially similar manner as descried above with respect to the implement tray 14 retaining the each interchangeable component 250a, 250b, 250c, 250d, 250e and/or of the cap, covering or protector 262 if the implement tray 14 is arranged in an “upside-down” orientation, tipped-over, or dropped, the optional lid 16 may also provide the same function for the implement tray 12. In some configurations, the optional flange portion 18b may secure the optional lid 16 in one of the closed or down orientation (see, e.g., FIGS. 1-2) with respect to the sidewall portion 24 of the implement tray 12 until a user applies a sufficient force or unlocks the flange portion 18b from the sidewall portion 24. Accordingly, when the optional lid 16 is retained in one of the closed or down orientation, the optional lid may secure and prevent ejection of the plurality of implements 200, 300a-300f from the implement tray 12 if the implement tray 14 is arranged in an “upside-down” orientation, tipped-over, or dropped.

In some configurations, the optional hinge portion 18a may be glued to one or both of the optional lid 16 and the sidewall portion 24 of the implement tray 12. Alternatively, the optional hinge portion 18a may be integrally formed with one of the optional lid 16 and the sidewall portion 24 of the implement tray 12.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A container for storing one or more implements, the container comprising:
a first implement tray having:
a sidewall portion defining a length that extends along a longitudinal axis from a first end of the sidewall portion that forms an opening to a second end of the sidewall portion, the sidewall portion defining an internal chamber that is configured to receive an axial portion of at least one implement of the one or more implements; and
a base portion disposed proximate the first end of the sidewall portion and radially extending outward from the longitudinal axis to an inner peripheral surface of the sidewall portion, the base portion comprising:
a top surface configured to support a head portion of the at least one implement of the one or more implements;
a bottom surface disposed opposite the top surface and opposing the internal chamber; and
at least one passage formed through a thickness of the base portion that extends between the top surface and the bottom surface of the base portion, the at least one passage defines a width sufficient to prevent passage of the head portion of the at least one implement through the at least one passage and permit passage of the axial portion of the at least one implement through the at least one passage when the head portion of the at least one implement is supported by the top surface.

2. The container of claim 1, wherein, when the head portion of the at least one implement of the one or more implements is supported by the top surface of the base portion, the axial portion of the at least one implement of the one or more implements axially extends through the at least one passage from a proximal end of the axial portion of the at least one implement that is attached to the head portion and terminates within the internal chamber at a distal end of the axial portion.

3. The container of claim 2, wherein the distal end of the axial portion of the at least one implement of the one or more implements is disposed within the internal chamber at a location between the bottom surface of the base portion and the second end of the sidewall portion.

4. The container of claim 1, wherein one or more passages of the at least one passage forms a straight cross-sectional shape.

5. The container of claim 1, wherein one or more passages of the at least one passage forms an arcuate cross-sectional shape.

6. The container of claim 1, wherein the at least one passage includes two or more passages, wherein the width of the two or more passages is the same.

7. The container of claim 1, wherein the width of the at least one passage is constant along a length of each passage of the at least one passage.

8. The container of claim 1, wherein the at least one passage comprises:
a first passage having an arcuate shape; and
a second passage having the same arcuate shape as the first passage.

9. The container of claim 8, wherein the first passage and the second passage are diametrically opposed from one another.

10. The container of claim 8, wherein the at least one passage comprises a third passage disposed between the first passage and the second passage.

11. The container of claim 1, further comprising a second implement tray removably attached to the first implement tray, the second implement tray comprising:
a base portion having a lower surface configured to support the second implement tray on a support surface; and
a sidewall portion forming an open end, wherein the open end includes an attachment surface configured to mate with a corresponding attachment feature formed by the first end of the sidewall portion of the first implement tray to permit removable attachment of the first implement tray with the second implement tray.

12. The container of claim 11, wherein the attachment surface of the open end of the sidewall portion of the second implement tray is configured to mate with the corresponding attachment feature formed by the first end of the sidewall portion of the first implement tray via compression or cooperating threads.

13. The container of claim 11, wherein a diameter formed by the first end of the sidewall portion of the first implement tray at the opening is different than a diameter of the open end of the sidewall portion of the second implement tray.

14. The container of claim 11, wherein the first end of the sidewall portion of the first implement tray is configured to support the first implement tray on the support surface when the second implement tray is not attached to the first implement tray.

15. The container of claim 11, wherein an outer surface of the sidewall portion of the second implement tray is radially aligned with an outer surface of the sidewall portion of the first implement tray when the first implement tray is attached to the second implement tray.

16. The container of claim 11, wherein the base portion of the second implement tray further comprises a component receiving surface configured to receive at least one implement of the one or more implements, the component receiving surface of the base portion of the second implement tray being axially spaced apart from the bottom surface of the base portion of the first implement tray when the second implement tray is attached to the first implement tray.

17. The container of claim 16, wherein the component receiving surface defines one or more recesses, wherein each recess of the one or more recesses is configured to retain the at least one implement of the one or more implements.

18. The container of claim 1, further comprising a lid configured to enclose the base portion of the first implement tray, the lid disposed proximate the second end of the sidewall portion of the first implement tray.

19. The container of claim 18, further comprising:
a hinge defining an axis of rotation substantially perpendicular to the longitudinal axis of the first implement tray,
wherein the lid is configured to rotate relative to the first implement tray via the hinge between:
an open position that permits access the at least one implement of the one or more implements; and
a closed position that prevents access to the at least one implement of the one or more implements.

20. The container of claim 19, wherein the hinge is fixedly attached to one of the lid or the first implement tray and configured to rotatably couple the other of the lid or the first implement tray.

21. The container of claim 19, wherein the hinge is integrally formed with one of the lid or the first implement tray and configured to rotatably couple the other of the lid or the first implement tray.

22. A storage device for storing one or more tools, the storage device comprising:
a circumferential wall defining a length that extends along a longitudinal axis from an open first end to a second end, the circumferential wall circumscribing an internal chamber configured to receive a respective axial portion of each tool; and
a tool tray disposed proximate the first end of the circumferential wall and radially extending outward from an axial center of the internal chamber to an inner peripheral surface of the circumferential wall, the tool tray comprising:
a top surface configured to support a respective head portion of each tool;
a bottom surface disposed on an opposite side of the tool tray than the top surface and opposing the internal chamber; and
one or more troughs formed through the top and bottom surfaces of the tool tray, each trough defining a respective width sufficient to prevent passage of the respective head portion of each tool through the trough and permit passage of the respective axial portion of each tool through the trough when the respective head portion is supported by the top surface.

23. The storage device of claim 22, wherein at least one of the one or more troughs comprises a straight cross-sectional shape.

24. The storage device of claim 22, wherein at least one of the one or more troughs comprises an arcuate cross-sectional shape.

25. The storage device of claim 22, wherein the one or more troughs formed through the top and bottom surfaces of the tool tray comprises:
a first trough having an arcuate shape;
a second trough having the same arcuate shape as the first trough; and
a third trough disposed between the first trough and the second trough.

26. The storage device of claim 25, wherein the first trough and the second trough are diametrically opposed from one another.

27. The storage device of claim 22, further comprising:
a base removably attached to the circumferential wall, the base comprising:
a substantially planar support surface configured to support the base on a surface;
an open end; and
a peripheral wall extending between the substantially planar support surface and the open end of the base,
wherein peripheral wall defines an attachment surface configured to mate with a corresponding attachment feature of the circumferential wall to permit removable attachment between the circumferential wall and the base.

28. The storage device of claim 27, wherein an outer surface of the peripheral wall is radially aligned with an outer surface of the circumferential wall when the base is attached to the circumferential wall.

29. The storage device of claim 27, wherein the base further comprises:
a component receiving surface configured to receive subcomponents of the one or more tools, the component receiving surface coaxial with the tool tray when the circumferential wall is attached to the base; and
a cavity defined by the component receiving surface and the peripheral wall of the base.

30. The storage device of claim 22, further comprising a lid configured to enclose the open first end.
